(19) United States
(12) Patent Application Publication
(10) Pub. No.: US 2021/0226193 A1
(43) Pub. Date: Jul. 22, 2021

(54) Method of Electrodeposition of Electroactive Species at Solid-Solid Interfaces

(71) Applicant: THE REGENTS OF THE UNIVERSITY OF MICHIGAN, Ann Arbor, MI (US)

(72) Inventors: JEFFREY SAKAMOTO, Ann Arbor, MI (US); MICHAEL WANG, Ann Arbor, MI (US)

(21) Appl. No.: 17/154,176

(22) Filed: Jan. 21, 2021

Related U.S. Application Data
(60) Provisional application No. 62/963,700, filed on Jan. 21, 2020.
(60) Provisional application No. 62/988,986, filed on Mar. 13, 2020.

(51) Int. Cl. H01M 4/04; H01M 10/0562; H01M 10/0585; H01M 10/052

(52) U.S. Cl. CPC H01M 4/0452; H01M 10/0562; H01M 2300/0071; H01M 10/0585; H01M 10/052; H01M 4/043

(57) ABSTRACT

The present disclosure relates to a method of electrodeposition using pulsed currents to improve the uniformity of electrodeposited materials at solid-solid interfaces. It has been demonstrated that films of electrodeposited metals can be robustly deposited at a solid-solid interface without damage to the solid-electrolyte. Furthermore, the effects of the pulse parameters, including current density, pulse width, and duty cycle have shown to have dramatic effects on the spatial distribution of the electrodeposited metal. This methodology can aid in the manufacturing of thin films and microscopic structures for application in advanced functional materials and electrochemical devices. In one embodiment, the method provides for anode-free manufacturing in which a battery is fabricated in the discharged state, with a bare current collector replacing the conventional anode, and a metal anode is then formed electrochemically on the first charge cycle by electroplating a metal contained within the cathode.

### CROSS-REFERENCES TO RELATED APPLICATIONS

This application is based on and claims priority to U.S. Patent Application No. 62/963,700 filed Jan. 21, 2020, and U.S. Patent Application No. 62/988,986 filed Mar. 13, 2020, which are hereby incorporated by reference herein in their entirety for all purposes.

### STATEMENT REGARDING FEDERALLY SPONSORED RESEARCH

This invention was made with government support under DE-AR0000653 awarded by the Department of Energy. The government has certain rights in the invention.

### BACKGROUND OF THE INVENTION

### 1. Field of the Invention

The invention relates to a method of electrodeposition of an electroactive species on a solid to achieve uniform films of electrodeposited materials using a pulsed current electrodeposition process. More particularly, the invention relates to anode-free manufacturing in which a battery is fabricated in the discharged state, with a bare current collector replacing the conventional anode, and a metal anode is then formed electrochemically on the first charge cycle by electroplating a metal contained within the cathode.

### 2. Description of the Related Art

Electrochemical deposition of an electroactive species onto a substrate is a widely used method for controlled manufacturing of microscopic structures and for surface engineering. In conventional electrodeposition, an electroactive species, typically a metal cation, is contained within a liquid electrolyte, and coupled with a working electrode and a counter electrode. When a potential is applied to the electrodes, an electrochemical reaction is produced at the working electrode/electrolyte interface which causes the metal cation to precipitate onto the working electrode as a pure metal. Because this technique can be used to apply thin films and microscopic structures of metals onto surfaces, a variety of different methods has been developed to gain more precise control of the morphologies of the electrodeposited metals. These techniques typically regulate factors such as electrolyte composition, surface chemistry, and electrochemical kinetics to deposit metals with the desired microstructures [Ref. 1-5]. However, given the inherently different natures of solid and liquid electrolytes, the mechanisms of electrodeposition are drastically different at solid-solid interfaces [Ref. 6-10]. As the electroactive species begins to precipitate and nucleate at the working electrode/electrolyte interface, the working electrode and electrolyte are forced to delaminate to accommodate the growth of a new solid phase between the two. Because contact must be maintained to supply electrons for redox reactions to occur, achieving uniform films of electrodeposited materials involves an intricate balance between the nucleus growth kinetics, the surface tension and diffusivity of the multiple interfaces, and the mechanical properties of the different components. With the growth of solid-electrolyte development for battery and fuel cell applications, electrodeposition at solid-solid interfaces is becoming increasingly relevant and therefore, methods to regulate the electrodeposition kinetics and mechanics at these interfaces are necessary to gain control over the microstructures of electrodeposited films at solid-solid interfaces. For some applications, like solid-state memory storage, sharp dendritic structures are required, while other applications, like energy storage, dense and conformal films are required.

Therefore, what is needed is an improved method for electrodeposition of electroactive materials on a solid substrate or a solid-state electrolyte that result in desirable morphologies.

### SUMMARY OF THE INVENTION

The microstructure of electrodeposited materials, typically metals, is influenced by factors such as concentration gradients in the electrolyte, surface chemistry and morphology, and electrochemical kinetics. In conventional electrochemical systems, which utilize a liquid electrolyte, there are a variety of different techniques that can be used to regulate these factors and allow for precise control over the microstructure of the deposited materials. However, with a solid-state electrolyte, the mechanical and chemical environment surrounding the electrode/electrolyte interface is inherently different, and therefore the mechanisms which govern the microstructure of electroplated materials can be drastically different. Therefore, the methodology for controlling the microstructure of the electroplated materials will differ when the electrolyte is a solid rather than a liquid. For many applications, uniform films of electrodeposited material are highly desirable morphologies. The present disclosure discloses a methodology for achieving uniform films of electrodeposited materials at the interface of a solid electrode and a solid electrolyte using a pulsed current electrodeposition process.

The ability for a metal substrate and solid-electrolyte to accommodate the volumetric expansion associated with electrodeposition at the interface is dependent on the mechanical properties of the individual components, including solid-electrolyte, electroactive species, and metal substrate, as well as the properties of the interface, including microstructure, adhesion, and electrochemical kinetics. The present disclosure provides a method of electrodepositing an electroactive species on a solid current collector clad with a solid-state electrolyte by placing the solid-state electrolyte material in contact with an electrode to form as layered structure, and passing current through the layered structure. The current collector can be a metal, metal alloy, or conductive composite (e.g., a polymer-metal composite or metal-metal oxide composite) that is non-reactive with the electroactive species and can be bound to the solid-electrolyte by means of diffusion bonding, a deposition process, sintering, or by mechanical pressure and can have thicknesses between 100 nanometers and 1 millimeter. The electrode can comprise a metal, a metal alloy, or any compound containing the electroactive species. The electrodeposition process is performed such that the electroactive species is depleted from the electrode and deposited onto the current collector at currents between 1 μA/cm² and 1 mA/cm².

In one aspect, the present disclosure provides a method of making an electrochemical device. The method includes the steps of: (a) providing a current collector clad with a solid-state electrolyte material; (b) placing the solid-state electrolyte material in contact with an electrode comprising an electroactive species to form a layered structure; (c) applying a pressure greater than 0 MPa to the layered structure; and (d) passing a current using a series of pulse cycles through the layered structure to create an interfacial layer comprising the electroactive species between the solid-state electrolyte material and the current collector, wherein the interfacial layer functions as an anode of the electrochemical device and the electrode functions as a cathode of the electrochemical device. In one embodiment of the method, step (c) comprises applying a pressure from 0.1 MPa to 100 MPa to the layered structure. In one embodiment of the method, step (c) comprises applying a pressure from 1 MPa to 10 MPa to the layered structure.

In the method, each pulse cycle may comprise (i) applying an on-current for a given pulse width, and (ii) applying an off-current for an amount of time based on a duty cycle and the pulse width, and the off-current has a first current density value which is less than a second current density value of the on-current. The on-current can be direct current in a range of 1 μA cm⁻² to 1 A cm⁻². The on-current can be direct current in a range of 0.01 mA cm⁻² to 1 mA cm⁻². The current can be direct current in a range of 1 μA cm⁻² to 1 mA cm⁻². The pulse width can be from 1 microsecond to 100 seconds. The pulse width can be from 1 second to 10 seconds. The off-current can be direct current in a range of −1 A cm⁻² to 0.9 μA cm⁻². The duty cycle can be from 0.1% to 99%. The duty cycle can be from 50% to 99%. The duty cycle can be from 70% to 99%. The duty cycle can be from 80% to 99%.

In one embodiment of the method, step (d) further comprises monitoring propagation of the electroactive species from the anode into the solid state electrolyte during passing the current using the series of pulse cycles through the layered structure, wherein each pulse cycle comprises (i) applying an on-current for a given pulse width, and (ii) applying an off-current for an amount of time based on a duty cycle and the pulse width, and wherein step (d) further comprises varying at least one of: (i) the pulse width, (ii) the amount of time, (iii) the duty cycle, (iv) a first current density value of the off-current, and (iv) a second current density value of the on-current, when a prediction of propagation of the electroactive species from the anode into the solid state electrolyte is made from the monitoring.

In one embodiment of the method, the current collector comprises a single material comprising a metal or a metal alloy. The current collector may comprise a material selected from the group consisting of nickel, molybdenum, titanium, zirconium, tantalum, alloy steel, stainless steel, nickel based super alloys, cobalt based super alloys, copper, aluminum, iron, or mixtures thereof. The current collector can have a thickness between 1 nanometer and 100 micrometers.

In one embodiment of the method, the solid-state electrolyte material comprises a material selected from the group consisting of lithium phosphorous oxynitride (LiPON), oxide based garnets, sodium super ionic conductors (NaSICON), lithium super ionic conductors (LiSICON), thio-LiSICONs, sulfide glass, polymers, or mixtures thereof. In one embodiment of the method, the solid-state electrolyte material is selected from the group consisting of lithium lanthanum zirconium oxide (LLZO), aluminum doped LLZO, gallium doped LLZO, niobium doped LLZO, tantalum doped LLZO, lithium aluminum titanium phosphate (LATP), lithium aluminum germanium phosphate (LAGP), lithium phosphorous sulfide (LPS), poly(ethylene oxide) (PEO), polyacrylonitrile (PAN), crystalline thermoplastic polymers, alkali metal cation-alumina, metal halides, or mixtures thereof. The solid-state electrolyte material can comprise lithium lanthanum zirconium oxide (LLZO) or a derivative thereof. In one embodiment of the method, the solid-state electrolyte material comprises a ceramic material having a formula of Li_{w}AₓM₂Re_{3-y}O_{z},
wherein w is 5-7.5,
wherein A is selected from B, Al, Ga, In, Zn, Cd, Y, Sc, Mg, Ca, Sr, Ba, and any combination thereof,
wherein x is 0-2,
wherein M is selected from Zr, Hf, Nb, Ta, Mo, W, Sn, Ge, Si, Sb, Se, Te, and any combination thereof,
wherein Re is selected from lanthanide elements, actinide elements, and any combination thereof,
wherein y is 0-0.75,
wherein z is 10.875-13.125, and
wherein the ceramic material has a garnet-type or garnet-like crystal structure.
   In one embodiment of the ceramic material, M is a combination of Zr and Ta. In one embodiment of the ceramic material, wherein M is Zr, and A is Al, and x is not 0. In one embodiment of the ceramic material, M is Zr, and A is Ga, and x is not 0. In one embodiment of the method, the solid-state electrolyte material comprises sodium-β-alumina and/or sodium-β″-alumina.

In one embodiment of the method, the solid-state electrolyte material is clad onto the current collector using at least one of diffusion-bonding, chemical vapor deposition, physical vapor deposition, atomic layer deposition, slurry casting and sintering, slurry casting and hot pressing, painting, powder coating, thermal spraying, cold spraying, aerosol deposition, flux deposition, electrodeposition, electroless chemical deposition, or combinations thereof. The solid-state electrolyte material can have a thickness between 1 nanometer and 100 micrometers.

In one embodiment of the method, the interfacial layer has a thickness between 1 nanometer and 100 micrometers.

In one embodiment of the method, the current collector is electrochemically blocking to the electroactive species. In one embodiment of the method, the current collector comprises a bimetal having a first layer comprising a first metallic material and a second layer comprising a second metallic material, wherein the first layer at least partially contacts the solid-state electrolyte material before step (d), and the second layer contacts the first layer. The first metallic material can be electrochemically blocking to the electroactive species. The first metallic material can be selected from the group consisting of nickel, molybdenum, titanium, zirconium, tantalum, nickel based super alloys, cobalt based super alloys, copper, or mixtures thereof, and the second material can be selected from the group consisting of aluminum, nickel, alloy steel, stainless steel, nickel based super alloys, or mixtures thereof. The first metallic material can comprise nickel, and the second material can comprise stainless steel. The first layer can have a thickness between 1 nanometer and 100 micrometers, and the second layer can have a thickness between 1 nanometer and 100 micrometers.

In one embodiment of the method, the electrode comprises a single material comprising a metal or a metal alloy. The electrode can comprise a material selected from the group consisting of lithium, sodium, silver, magnesium, calcium, cobalt, iron, potassium, copper, or mixtures thereof. The electrode can comprise lithium.

In one embodiment of the method, the electrode comprises a lithium host material is selected from the group consisting of (i) LiC₆, (ii) lithium metal oxides wherein the metal is one or more aluminum, cobalt, iron, manganese, nickel and vanadium, and (iii) lithium-containing phosphates having a general formula LiMPO₄ wherein M is one or more of cobalt, iron, manganese, and nickel. The electrode can further comprise a binder and a conductive additive. The binder can comprise a polymeric material, and the conductive additive can comprise a carbon compound. The electrode can be a conductive composite comprising the electroactive species.

In one embodiment of the method, step (b) comprises evaporating a first layer of lithium on the solid-state electrolyte material and thereafter pressing a lithium foil to the first layer such that the electrode comprises the first layer of lithium and the lithium foil.

In one embodiment of the method, step (c) comprises applying the pressure to the layered structure at a temperature from 25° C. to 180° C.

In one embodiment of the method, no damage to the solid electrolyte material occurs during step (d). In one embodiment of the method, no dendrite penetration into the solid electrolyte material occurs during step (d).

In one embodiment of the method, the interfacial layer has a uniform thickness after step (d). In one embodiment of the method, the interfacial layer has a surface coverage of 5% or greater with the solid-state electrolyte after step (d). The interfacial layer can have a surface coverage of 70% or greater with the solid-state electrolyte after step (d). The interfacial layer can have complete surface contact with the solid-state electrolyte material after step (d).

In one embodiment of the method, the current collector clad with the solid-state electrolyte material provided in step (a) has a porosity between 0.1% and 99% at an interface between the current collector and the solid-state electrolyte material. In one embodiment of the method, the current collector clad with the solid-state electrolyte material provided in step (a) has a porosity between 0.1° A and 10% at an interface between the current collector and the solid-state electrolyte material.

In one embodiment of the method, an interfacial resistance between the current collector and the solid-state electrolyte material provided in step (a) is less than 10,000 ohm cm². The interfacial resistance between the current collector and the solid-state electrolyte material provided in step (a) can be less than 1,000 ohm cm².

In one embodiment of the method, an interfacial resistance between the interfacial layer and the solid state electrolyte after step (d) is less than 100 ohm cm². The interfacial resistance between the interfacial layer and the solid state electrolyte after step (d) can be less than 25 ohm cm².

In one embodiment of the method, an RMS surface roughness of a surface of the solid state electrolyte material clad with the current collector is 5 micrometers or less. The RMS surface roughness of a surface of the solid state electrolyte material clad with the current collector can be 500 nanometers or less.

In one embodiment of the method, the interfacial layer has a density such that the anode exhibits non-blocking behavior to the electroactive species. In one embodiment of the method, the interfacial layer does not show the formation of dendrites after step (d).

In another aspect, the present disclosure provides a method of making an electrochemical device. The method can include the steps of: (a) providing a current collector clad with a solid-state electrolyte material comprising a doped lithium lanthanum zirconium oxide; (b) placing the solid-state electrolyte material in contact with an electrode comprising an electroactive species to form a layered structure; and (c) passing a current using a series of pulse cycles through the layered structure to create an interfacial layer comprising the electroactive species between the solid-state electrolyte material and the current collector, wherein the interfacial layer functions as an anode of the electrochemical device and the electrode functions as a cathode of the electrochemical device.

In one embodiment of the method, the solid-state electrolyte material comprises aluminum doped lithium lanthanum zirconium oxide, or gallium doped lithium lanthanum zirconium oxide, or niobium doped lithium lanthanum zirconium oxide, or tantalum doped lithium lanthanum zirconium oxide. In one embodiment of the method, the solid-state electrolyte material comprises a ceramic material having a formula of Li_{w}AₓM₂Re_{3-y}O_{z},
wherein w is 5-7.5,
wherein A is selected from B, Al, Ga, In, Zn, Cd, Y, Sc, Mg, Ca, Sr, Ba, and any combination thereof,
wherein x is 0-2,
wherein M is selected from Zr, Hf, Nb, Ta, Mo, W, Sn, Ge, Si, Sb, Se, Te, and any combination thereof,
wherein Re is selected from lanthanide elements, actinide elements, and any combination thereof,
wherein y is 0-0.75,
wherein z is 10.875-13.125, and
wherein the ceramic material has a garnet-type or garnet-like crystal structure.
   In one embodiment of the ceramic material, M is a combination of Zr and Ta. In one embodiment of the ceramic material, wherein M is Zr, and A is Al, and x is not 0. In one embodiment of the ceramic material, M is Zr, and A is Ga, and x is not 0.

In one embodiment of the method, the step (c) further comprises applying a pressure greater than 0 MPa to the layered structure. In one embodiment of the method, the pressure is from 0.1 MPa to 100 MPa. In one embodiment of the method, the pressure is from 1 MPa to 10 MPa.

In another aspect, the present disclosure provides a method of making an electrochemical device. The method can include the steps of: (a) providing a current collector clad with a solid-state electrolyte material; (b) placing the solid-state electrolyte material in contact with an electrode comprising an electroactive species to form a layered structure; and (c) passing a current using a series of pulse cycles through the layered structure to create an interfacial layer comprising the electroactive species between the solid-state electrolyte material and the current collector, wherein the interfacial layer functions as an anode of the electrochemical device and the electrode functions as a cathode of the electrochemical device, wherein the solid-state electrolyte material comprises a ceramic material having a formula of Li_{w}AₓM₂Re_{3-y}O_{z},
wherein w is 5-7.5,
wherein A is selected from B, Al, Ga, In, Zn, Cd, Y, Sc, Mg, Ca, Sr, Ba, and any combination thereof,
wherein x is 0-2,
wherein M is selected from Zr, Hf, Nb, Ta, Mo, W, Sn, Ge, Si, Sb, Se, Te, and any combination thereof,
wherein Re is selected from lanthanide elements, actinide elements, and any combination thereof,
wherein y is 0-0.75,
wherein z is 10.875-13.125,
wherein the ceramic material has a garnet-type or garnet-like crystal structure, and
wherein when x is 0, M is two or more of Zr, Hf, Nb, Ta, Mo, W, Sn, Ge, Si, Sb, Se, and Te.
   In one embodiment of the ceramic material, Re is lanthanum. In one embodiment of the ceramic material, M is a combination of Zr and Ta. In one embodiment of the ceramic material, M is Zr, and A is Al, and x is not 0. In one embodiment of the ceramic material, M is Zr, and A is Ga, and x is not 0. The solid-state electrolyte can comprise Li_{6.5}La₃Zr_{1.5}Ta_{0.5}O₁₂.

In one embodiment of the method, the step (c) further comprises applying a pressure greater than 0 MPa to the layered structure. In one embodiment of the method, the pressure is from 0.1 MPa to 100 MPa. In one embodiment of the method, the pressure is from 1 MPa to 10 MPa.

These and other features, aspects, and advantages of the present disclosure will become better understood upon consideration of the following detailed description, drawings, and appended claims.

### BRIEF DESCRIPTION OF THE DRAWINGS

FIG. 1 shows a schematic of a lithium metal battery.

FIG. 1A is an exemplary schematic of a pulsed current electroplating profile and pulse parameters.

FIG. 2A is an exemplary electrochemical characterization of DC potential response during lithium electrodeposition according to one embodiment of the present disclosure.

FIG. 2B is an exemplary electrochemical characterization of AC impedance of an electrochemical cell before and after lithium electrodeposition according to one embodiment of the present disclosure.

FIG. 3 shows in panel a), an image of electrodeposited lithium onto LLZO after removal of the nickel substrate wherein non-uniform deposition of lithium results in clearly metallic regions (lithium) and clearly non-metallic regions (LLZO); in panel b), an exemplary electrodeposited lithium morphology for 100% duty cycle (DC current) according to one embodiment of the present disclosure; in panel c), an exemplary electrodeposited lithium morphology for 80% duty cycle and low current density according to one embodiment of the present disclosure; in panel d), an exemplary electrodeposited lithium morphology for 80% duty cycle and high current density according to one embodiment of the present disclosure; and in panel e), an exemplary electrodeposited lithium morphology wherein a significant amount of lithium is deposited, exceeding the thickness of the nickel substrate according to one embodiment of the present disclosure.

FIG. 4 shows cross-sectional SEM-FIB analysis of the LLZO and the current collector interface. SEM in panel (a) as assembled, in panel (b) after plating 5 mAh cm⁻² of Li, and in panel (c) after plating and then stripping of 5 mAh cm⁻² of Li. Elemental maps for Cu and Zr at the interface in panel (d) as assembled, in panel (e) after plating, and in panel (f) after plating and stripping. Metallic Li is observed under secondary electrons in between the Cu and LLZO layer in panel (b) but cannot be detected since the characteristic x-ray energy falls outside of the detection range of EDS.

FIG. 5 shows low magnification SEM of FIB-milled cross-Sections from FIG. 4. In panel (a) Cu current collector as laminated onto LLZO, in panel (b) after 5 mAh cm⁻² of Li is plated, and in panel (c) after 5 mAh cm⁻² of Li is plated and stripped. The intermediate Li layer in between the Cu and the LLZO in panel (b) more clearly shows textural features at lower magnifications which indicates the presence of an intermediate phase rather than empty space, despite the high color contrast. Not all regions of the interface after stripping 5 mAh cm⁻² of the plated Li exhibit such a prominent separation between Cu and LLZO that is observed in panel (c). One such region of a less pronounced separation is shown in panel (d), which exhibits a smaller gap between Cu and LLZO but is still more pronounced than in panel (a) and shows a similar residue between Cu and LLZO that is also observed in panel (c).

### DETAILED DESCRIPTION OF THE INVENTION

Before the present invention is described in further detail, it is to be understood that the invention is not limited to the particular embodiments described. It is also to be understood that the terminology used herein is for the purpose of describing particular embodiments only, and is not intended to be limiting. The scope of the present invention will be limited only by the claims. As used herein, the singular forms “a”, “an”, and “the” include plural embodiments unless the context clearly dictates otherwise.

It should be apparent to those skilled in the art that many additional modifications beside those already described are possible without departing from the inventive concepts. In interpreting this disclosure, all terms should be interpreted in the broadest possible manner consistent with the context. Variations of the term “comprising”, “including”, or “having” should be interpreted as referring to elements, components, or steps in a non-exclusive manner, so the referenced elements, components, or steps may be combined with other elements, components, or steps that are not expressly referenced. Embodiments referenced as “comprising”, “including”, or “having” certain elements are also contemplated as “consisting essentially of” and “consisting of” those elements, unless the context clearly dictates otherwise. It should be appreciated that aspects of the disclosure that are described with respect to a system are applicable to the methods, and vice versa, unless the context explicitly dictates otherwise.

As used herein, a “cell” or “electrochemical cell” is a basic electrochemical unit that contains the electrodes and an electrolyte. As used herein, “electrochemical cells” are contemplated as being rechargeable cells, also referred to as secondary cells, unless the context clearly dictates otherwise. In an electrochemical cell or electrochemical device, the “anode” is defined as the electrode that undergoes oxidation, therefore losing electrons, during discharge. The “cathode” is defined as the electrode that undergoes reduction, therefore gaining electrons, during discharge. These electrochemical roles are reversed in an electrochemical cell or electrochemical device during the charging process, but the “anode” and “cathode” electrode designations herein remain the same.

As used herein, “uniform thickness” means the thickness of an element (e.g., a layer) has a thickness nonuniformity of ±25% or less from one end to an opposite end of the element. For example, a layer having a minimum thickness of 100-25 and a maximum thickness of 100+25 from one end to an opposite end of the layer would have a thickness nonuniformity of ±25%.

Numeric ranges disclosed herein are inclusive of their endpoints. For example, a numeric range of between 1 and 10 includes the values 1 and 10. When a series of numeric ranges are disclosed for a given value, the present disclosure expressly contemplates ranges including all combinations of the upper and lower bounds of those ranges. For example, a numeric range of between 1 and 10 or between 2 and 9 is intended to include the numeric ranges of between 1 and 9 and between 2 and 10.

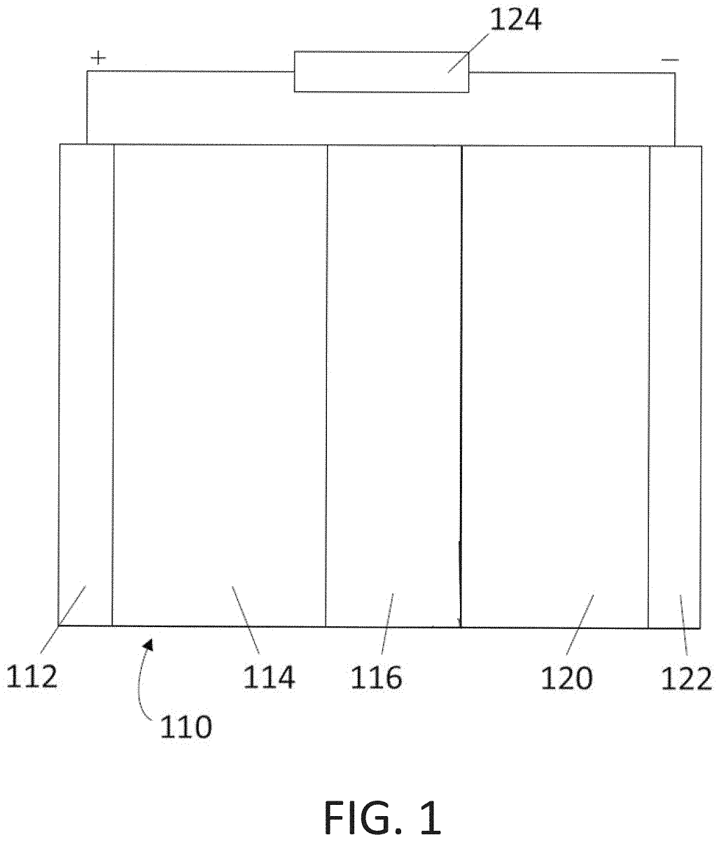

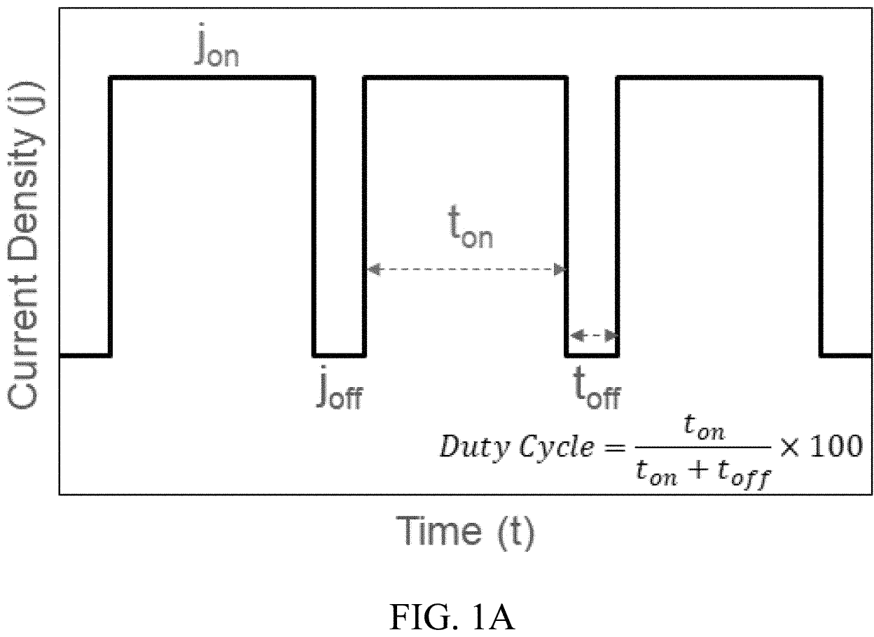

One embodiment of a method of the invention allows for anode-free manufacturing in which a battery is fabricated in the discharged state, with a bare current collector replacing the conventional anode, and a metal anode is then formed electrochemically on the first charge cycle by electroplating a metal contained within the cathode. FIG. 1 shows a non-limiting example of a lithium metal battery 110 that may manufactured using an embodiment of the present disclosure. The lithium metal battery 110 of FIG. 1 includes a first current collector 112 (i.e., aluminum) in contact with a cathode 114. A solid-state electrolyte 116 is arranged between the cathode 114 and an anode 120, which is in contact with a second current collector 122 (i.e., copper). The first current collector 112 and the second current collector 122 of the lithium metal battery 110 may be in electrical communication with an electrical component 124. The electrical component 124 could place the lithium metal battery 110 in electrical communication with an electrical load that discharges the battery or a charger that charges the battery.

The first current collector 112 and the second current collector 122 can comprise a conductive metal or any suitable conductive material. In some embodiments, the first current collector 112 and the second current collector 122 may be a single material comprising a metal or a metal alloy. If a single material, the first current collector 112 and the second current collector 122 can comprise a material selected from the group consisting of nickel, molybdenum, titanium, zirconium, tantalum, alloy steel, stainless steel, nickel based super alloys (e.g., Inconel), cobalt based super alloys, copper, aluminum, or mixtures, combinations and alloys thereof. In some embodiments, the first current collector 112 and the second current collector 122 have a thickness between 1 nanometer and 100 micrometers, between 10 nanometers and 60 micrometers, or between 900 nanometers and 25 micrometers. It is to be appreciated that the thicknesses depicted in FIG. 1 are not drawn to scale. Further, it is to be appreciated that the thickness of the first current collector 112 and the second current collector 122 may be different.

In some embodiments, a suitable cathode 114 of the lithium metal battery 110 is a lithium host material capable of storing and subsequently releasing lithium ions. An example cathode active material is a lithium metal oxide wherein the metal is one or more aluminum, cobalt, iron, manganese, nickel and vanadium. Non-limiting example lithium metal oxides are LiCoO₂ (LCO), LiFeO₂, LiMnO₂ (LMO), LiMn₂O₄, LiNiO₂ (LNO), LiNiₓCo_{y}O₂, LiMnₓCo_{y}O₂, LiMnₓNi_{y}O₂, LiMnₓNi_{y}O₄, LiNiₓCo_{y}Al_{z}O₂ (NCA), LiNi_{1/3}Mn_{1/3}Co_{1/3}O₂ and others. Another example cathode active material is a lithium-containing phosphate having a general formula LiMPO₄ wherein M is one or more of cobalt, iron, manganese, and nickel, such as lithium iron phosphate (LFP) and lithium iron fluorophosphates. Another example cathode active material is a cathode active material having a formula LiNiₓMn_{y}Co_{z}O₂, wherein x+y+z=1 and x:y:z=1:1:1 (NMC 111), x:y:z=4:3:3 (NMC 433), x:y:z=5:2:2 (NMC 522), x:y:z=5:3:2 (NMC 532), x:y:z=6:2:2 (NMC 622), or x:y:z=8:1:1 (NMC 811). Many different elements, e.g., Co, Mn, Ni, Cr, Al, or Li, may be substituted or additionally added into the structure to influence electronic conductivity, ordering of the layer, stability on delithiation and cycling performance of the cathode materials. The cathode active material can be a mixture of any number of these cathode active materials. Another example cathode active material is LiC₆. In other embodiments, a suitable material for the cathode 114 of the lithium metal battery 110 is porous carbon (for a lithium air battery), or a sulfur containing material (for a lithium sulfur battery). The cathode 114 may have a thickness between 1 nanometer and 100 micrometers, between 10 nanometers and 50 micrometers, or between 100 nanometers and 10 micrometers

In some embodiments, a suitable anode 120 of the lithium metal battery 110 consists of in situ formed (e.g., electroplated) lithium metal. Another example anode 120 material consists essentially of in situ formed lithium metal. In other embodiments, a suitable anode 120 consists of in situ formed magnesium, sodium, or zinc metal. In other embodiments, a suitable anode 120 consists essentially of in situ formed magnesium, sodium, or zinc metal.

An example solid-state electrolyte 116 material for the lithium metal battery 110 can include any suitable solid electrolyte capable of conducting metal ions. For example, the solid-state electrolyte may be lithium phosphorous oxynitride (LiPON). The solid-state electrolyte may be an oxide based garnet such as lithium lanthanum zirconium oxide (LLZO), aluminum doped LLZO, gallium doped LLZO, niobium doped LLZO, or tantalum doped LLZO. The solid-state electrolyte may be a sodium super ionic conductor (NaSICON) such as lithium aluminum titanium phosphate (LATP). The solid-state electrolyte may be lithium super ionic conductor (LiSICON). The solid-state electrolyte may be a thio-LISICON. The solid-state electrolyte may be lithium aluminum germanium phosphate (LAGP). The solid-state electrolyte may be sulfide glass such as lithium phosphorous sulfide (LPS). The solid-state electrolyte may be sodium-β-alumina or sodium-β″-alumina. The solid-state electrolyte may be a polymer such as polyethylene oxide (PEO), polyacrylonitrile (PAN), or a crystalline thermoplastic polymer. The solid-state electrolyte may comprise a mixture of any of the electrolytes listed above. The solid-state electrolyte may have a thickness between 1 nanometer and 100 micrometers, between 100 nanometers and 50 micrometers, or between 1 micrometer and 25 micrometers.

In another embodiment of the lithium metal battery 110, the solid-state electrolyte 116 for the lithium metal battery 110 comprises a ceramic material having a formula of Li_{w}AₓM₂Re_{3-y}O_{z},

wherein w is 5-7.5,

wherein A is selected from B, Al, Ga, In, Zn, Cd, Y, Sc, Mg, Ca, Sr, Ba, and any combination thereof,

wherein x is 0-2,

wherein M is selected from Zr, Hf, Nb, Ta, Mo, W, Sn, Ge, Si, Sb, Se, Te, and any combination thereof,

wherein Re is selected from lanthanide elements, actinide elements, and any combination thereof,

wherein y is 0-0.75,

wherein z is 10.875-13.125, and

wherein the ceramic material has a garnet-type or garnet-like crystal structure.

In some embodiments of the solid-state electrolyte 116, M is Zr and A is Al and x is not 0, or M is Zr and A is Ga and x is not 0, or M is a combination of Zr and Ta. In one embodiment, the solid-state electrolyte comprises Li_{6.5}La₃Zr_{1.5}Ta_{0.5}O₁₂.

As part of an anode-free method for manufacturing the lithium metal battery 110, we disclose a method of electrodepositing an electroactive species from a solid-electrolyte that utilizes a pulsed current scheme to form uniform films at a solid substrate/solid electrolyte interface in a layered structure comprising a current collector clad with a solid-state electrolyte material which is in contact with an electrode comprising an electroactive species. The solid substrate can be the current collector 122 of the lithium metal battery 110. The current collector 122 can be electrochemically blocking to the electroactive species. The term “blocking” as used herein can refer to a current collector comprising a material with sufficiently low electroactive species solubility as determined by the thermodynamic phase diagrams such that the material can be considered non-reactive with the electroactive species. The solid electrolyte can be the solid-state electrolyte 116 of the lithium metal battery 110. The electrode can be a lithiated cathode 114 of the lithium metal battery 110. The electroactive species can be lithium. The solid-state electrolyte material may be clad onto the current collector using any suitable method of attachment. For example, cladding the solid-state electrolyte onto the current collector may be accomplished using diffusion bonding, chemical vapor deposition, physical vapor deposition, atomic layer deposition, slurry casting and sintering, slurry casting and hot pressing, painting, powder coating, thermal spraying, cold spraying, aerosol deposition, flux deposition, electrodeposition, electroless chemical deposition, or combinations thereof.

The electrodeposition occurs in a periodic pulsed current scheme for the layered structure, which involves applying a non-zero DC on-current for a given pulse width. The on-pulse is followed by an off-pulse at a lower current density for an amount of time determined by the duty cycle. The sequential on-pulse and off-pulse is then repeated in a periodic manner until the appropriate mass of material has been electroplated as an interfacial layer, e.g., the anode 120. Because the governing mechanisms of electrodeposition are fundamentally different for solid and liquid electrolytes, the control schemes for achieving the desired microstructures are different in the solid-state system of the present disclosure. In the case of the solid substrate—solid electrolyte interface, the current densities, pulse width, and duty cycle play an important role in the distribution and number density of stable nuclei, relaxation of internal stresses in the cell, and the controlled delamination of the substrate and electrolyte. Therefore, these parameters can be optimized to attain the desired uniformity of the electroplated material comprising the interfacial layer (anode 120) between the current collector 122 and the solid-state electrolyte 116. Given the rigid constraints between two solids, the pulsed current is also advantageous in depositing material at the solid substrate—solid electrolyte interface without generating overly large mechanical deformations that could result in fracture of the surrounding components, e.g., the solid-state electrolyte 116.

Without intending to be bound by theory, it is believed that during the periodic pulsed current scheme of the method of the invention, the in situ plated metal forming the interfacial layer comprising the anode 120 progresses from the formation of isolated metal patches between the current collector 122 and the solid-state electrolyte 116 such that gaps are present in the interfacial layer, to the coalescence of the metal patches, and to the formation of a metal interfacial layer having uniform thickness between the current collector 122 and the solid-state electrolyte 116 wherein the interfacial layer can have complete surface coverage with the solid-state electrolyte 116.

The thickness of the interfacial layer can have a thickness nonuniformity of ±25% from one end to an opposite end of the interfacial layer. The thickness of the interfacial layer can have a thickness nonuniformity of ±20% from one end to an opposite end of the interfacial layer. The thickness of the interfacial layer can have a thickness nonuniformity of ±15% from one end to an opposite end of the interfacial layer. The thickness of the interfacial layer can have a thickness nonuniformity of ±10% from one end to an opposite end of the interfacial layer. The thickness of the interfacial layer can have a thickness nonuniformity of ±5% from one end to an opposite end of the interfacial layer. The thickness of the interfacial layer can have a thickness nonuniformity of ±2% from one end to an opposite end of the interfacial layer.

The interfacial layer can have a surface coverage of 5% or greater with the solid-state electrolyte. The interfacial layer can have a surface coverage of 70% or greater with the solid-state electrolyte. The interfacial layer can have a surface coverage of 80% or greater with the solid-state electrolyte. The interfacial layer can have a surface coverage of 85% or greater with the solid-state electrolyte. The interfacial layer can have a surface coverage of 90% or greater with the solid-state electrolyte. The interfacial layer can have a surface coverage of 95% or greater with the solid-state electrolyte. The interfacial layer can have a surface coverage of 97% or greater with the solid-state electrolyte. The interfacial layer can have a surface coverage of 98% or greater with the solid-state electrolyte. The interfacial layer can have a surface coverage of 99% or greater with the solid-state electrolyte.

In one embodiment of the method, the current collector clad with the solid-state electrolyte material can have a porosity between 0.1° A and 99% at an interface between the current collector and the solid-state electrolyte material. In another embodiment of the method, the current collector clad with the solid-state electrolyte material can have a porosity between 0.1% and 90% at an interface between the current collector and the solid-state electrolyte material. In another embodiment of the method, the current collector clad with the solid-state electrolyte material can have a porosity between 0.1% and 70% at an interface between the current collector and the solid-state electrolyte material. In another embodiment of the method, the current collector clad with the solid-state electrolyte material can have a porosity between 0.1% and 50% at an interface between the current collector and the solid-state electrolyte material. In another embodiment of the method, the current collector clad with the solid-state electrolyte material can have a porosity between 0.1% and 30% at an interface between the current collector and the solid-state electrolyte material. In another embodiment of the method, the current collector clad with the solid-state electrolyte material can have a porosity between 0.1% and 10% at an interface between the current collector and the solid-state electrolyte material. In another embodiment of the method, the current collector clad with the solid-state electrolyte material can have a porosity between 0.1% and 5% at an interface between the current collector and the solid-state electrolyte material. In another embodiment of the method, the current collector clad with the solid-state electrolyte material can have a porosity between 0.1% and 2% at an interface between the current collector and the solid-state electrolyte material.

In the method, the interfacial resistance between the current collector and the solid-state electrolyte material can be less than 10,000 ohm cm², or less than 1000 ohm cm², or less than 500 ohm cm², or less than 450 ohm cm², or less than 400 ohm cm², or less than 350 ohm cm², or less than 300 ohm cm², or less than 250 ohm cm², or less than 200 ohm cm², or less than 150 ohm cm², or less than 100 ohm cm², or less than 75 ohm cm², or less than 50 ohm cm², or less than 25 ohm cm², or less than 10 ohm cm².

The method can produce an interfacial layer that has between 0.1° A and 99% surface contact with the solid-state electrolyte material, or between 10% and 99% surface contact with the solid-state electrolyte material, or between 50% and 99% surface contact with the solid-state electrolyte material, or between 70% and 99% surface contact with the solid-state electrolyte material, or between 80% and 99% surface contact with the solid-state electrolyte material, or between 90% and 99% surface contact with the solid-state electrolyte material, or between 95% and 99% surface contact with the solid-state electrolyte material.

In the method, the resulting interfacial resistance between the interfacial layer and the solid state electrolyte can be less than 1000 ohm cm², or less than 500 ohm cm², or less than 450 ohm cm², or less than 400 ohm cm², or less than 350 ohm cm², or less than 300 ohm cm², or less than 250 ohm cm², or less than 200 ohm cm², or less than 150 ohm cm², or less than 100 ohm cm², or less than 75 ohm cm², or less than 50 ohm cm², or less than 25 ohm cm², or less than 10 ohm cm².

In the method, the RMS surface roughness of the surface of the solid-state electrolyte material be can be 5 micrometers or less, or 1 micrometer or less, or 500 nanometers or less, or 250 nanometers or less, or 100 nanometers or less, or 50 nanometers or less.

As discussed above, in one aspect, the present disclosure provides a method of making an electrochemical device. The method can comprise: (a) providing a current collector clad with a solid-state electrolyte material; (b) placing the solid-state electrolyte material in contact with an electrode comprising an electroactive species to form a layered structure; (c) applying a pressure of greater than 0 MPa to the layered structure; and (d) passing a current using a series of pulse cycles through the layered structure to create an interfacial layer comprising the electroactive species between the solid-state electrolyte material and the current collector. The interfacial layer functions as an anode of the electrochemical device and the electrode functions as a cathode of the electrochemical device.. After step (d), the interfacial layer may have a uniform thickness. In the method of electrodepositing an electroactive species on a solid, step (d) may be repeated several times to create a plurality of layered structures. The electroactive species may be any chemical species that is able to participate in controlled redox reactions.

In one aspect, the pressure can be applied to the layered structure at a pressure between 0.1 and 100 MPa, or between 0.2 and 100 MPa, or between 0.4 and 100 MPa, or between 0.6 and 100 MPa, or between 0.8 and 100 MPa, or between 1 and 100 MPa, or between 1.2 and 100 MPa, or between 1.4 and 100 MPa, or between 1.6 and 100 MPa, or between 1.8 and 100 MPa, or between 2 and 100 MPa, or between 10 and 100 MPa, or between 50 and 100 MPa. In another aspect, the pressure can be between 0.1 and 100 MPa, or between 0.1 and 50 MPa, or between 0.1 and 10 MPa, or between 0.1 and 5 MPa, or between 0.1 and 2 MPa, or between 0.1 and 1.8 MPa, or between 0.1 and 1.6 MPa, or between 0.1 and 1.4 MPa, or between 0.1 and 1.2 MPa, or between 0.1 and 1 MPa, or another range suitable for pressing the layered structure.

In one aspect, the layered structure can be pressed at a temperature between 25° C. and 180° C., or between 50° C. and 180° C., or between 100° C. and 180° C., or between 125° C. and 180° C., or between 140° C. and 180° C., or between 145° C. and 180° C., or between 150° C. and 180° C., or between 155° C. to 180° C., or between 160° C. and 180° C. In another aspect, the temperature can be between 25° C. and 180° C., or between 25° C. and 175° C., or between 25° C. and 170° C., or between 25° C. and 165° C., or between 25° C. and 160° C., or another range suitable for pressing the layered structure.

In one embodiment, step (d) of the method may further comprise passing the current using a series of pulse cycles, wherein each pulse cycle comprises (i) applying an on-current for a given pulse width, and (ii) applying an off-current for an amount of time based on a duty cycle and the pulse width. The electroactive species (e.g., lithium) nucleates and grows during on-current, and flows and flattens under pressure during off-current. FIG. 1A is an exemplary schematic of a pulsed current electroplating profile and pulse parameters, according to one embodiment of the present disclosure. Each pulse cycle comprises an on-current density value jₒₙ, an pulse width tₒₙ, an off-current density j_{off}, and an off-current time t_{off}, wherein the off-current density value j_{off} is less than the on-current density value jₒₙ, and the off-current time t_{off} is less than the pulse width tₒₙ. The on-current is turned on for a period of time called pulse width tₒₙ, followed by an off-current for a period of time t_{off}.

In one embodiment, the on-current of step (d) may have a non-zero current density value jₒₙ, and is responsible for the majority of the electrodeposition. In one aspect, the on-current has a density value jₒₙ between 1 μA cm⁻² and 1 A cm⁻², or between 0.01 mA cm⁻² and 1 A cm⁻², or between 0.1 mA cm⁻² and 1 A cm⁻², or between 0.2 mA cm⁻² and 1 A cm⁻², or between 0.4 mA cm⁻² and 1 A cm⁻², or between 0.6 mA cm⁻² and 1 A cm⁻². In another aspect, the on-current has a density value j on between 1 μA cm⁻² and 1 A cm⁻², or between 1 μA cm⁻² and 0.1 A cm⁻², or between 1 μA cm⁻² and 100 mA cm⁻², or between 1 μA cm⁻² and 1 mA cm⁻², or between 1 μA cm⁻² and 0.8 mA cm⁻², or between 1 μA cm⁻² and 0.6 mA cm⁻², or another range suitable for electrodeposition.

In one embodiment, the on-current of step (d) may have a pulse width tₒₙ. The pulse width tₒₙ is the length of time for which the on-current is applied, and may have a value between 1 microsecond to 100 seconds, or between 100 microseconds to 100 seconds, or between 1 millisecond to 100 seconds, or between 100 millisecond to 100 seconds, or between 1 second to 100 seconds, or between 10 seconds to 100 seconds, or between 1 microsecond to 10 seconds, or between 1 microsecond to 1 second, or between 1 microsecond to 100 millisecond, or between 1 microsecond to 1 millisecond, or between 1 microsecond to 10 microseconds, or another range suitable for electrodeposition. In one embodiment, the on-current of step (c) may have a pulse width tₒₙ between 1 second and 10 seconds.

In one embodiment, the off-current of step (d) may have a density value j off, which is less than the density value of the on-current jₒₙ, and is responsible for zero electrodeposition, some electrodeposition, or stripping of the electrodeposited material. In one aspect, the off-current may have a density value j_{off} between −1 A cm⁻² and 0.9 μA cm⁻², or between −0.5 A cm⁻² and 0.9 μA cm⁻², or between −0.1 A cm⁻² and 0.9 μA cm⁻². In another aspect, the off-current may have a density value between −1 A cm⁻² and 0.9 μA cm⁻², or between −1 A cm⁻² and 0.5 μA cm⁻², or between −1 A cm⁻² and 0.2 μA cm⁻², or between −1 A cm⁻² and 0.1 μA cm⁻², or another range suitable for electrodeposition.

In one embodiment, the duty cycle of step (d) is the percentage of time in which the on-current is applied in a single on/off cycle, calculated by the following equation:

$$Duty cycle ( \% ) = \frac{{t}_{o n}}{{t}_{o n} + {t}_{off}} * 100 \%$$

In one aspect, the duty cycle maybe from 0.1% to 99%, or from 50% to 99%, or from 70% to 99%, or from 75% to 99%. In another aspect, the duty cycle maybe from 0.1% to 99%, or from 0.1% to 90%, or from 0.1% to 85%.

In another embodiment, the method may further comprise monitoring propagation of the electroactive species from the anode into the solid state electrolyte during passing the current using the series of pulse cycles through the layered structure. Video microscopy is a non-limiting example technique for monitoring propagation of the electroactive species from the anode into the solid state electrolyte. Each pulse cycle may comprise (i) applying an on-current for a given pulse width, and (ii) applying an off-current for an amount of time based on a duty cycle and the pulse width. This embodiment of the method comprises varying at least one of: (i) the pulse width, (ii) the amount of time, (iii) the duty cycle, (iv) a first current density value of the off-current, and (iv) a second current density value of the on-current, when a prediction of propagation of the electroactive species from the anode into the solid state electrolyte is made from the monitoring.

In another embodiment, step (b) of the method may further comprise evaporating a first layer of metal on the solid-state electrolyte material and thereafter pressing a metal foil to the first layer such that the electrode comprises the first layer of metal and the metal foil. In one embodiment, the metal may be lithium. In one embodiment, the metal foil may be lithium foil. An initial layer of lithium metal may be deposited on each side of the solid-state material using an Angstrom Engineering lithium evaporator. A lithium foil may then be pressed on top of the initially evaporated lithium layer under any of the pressures described above.

More generally, the present disclosure provides a method of electrodeposition of an electroactive species on a solid substrate. In one embodiment, this method may comprise passing a pulsed current through a layered structure comprising a substrate clad with a solid-state electrolyte material which is in contact with an electrode comprising an electroactive species, wherein passing a pulsed current can generate (e.g., electroplate) an interfacial layer between the solid-state electrolyte material and the substrate. The pulsed current involves applying a non-zero DC on-current for a given pulse width. The on-current may be from 1 μA cm⁻² to 1 A cm⁻², or from 0.01 mA cm⁻² to 10 mA cm⁻², or from 0.1 mA cm⁻² to 1 mA cm⁻², or from or from 0.1 mA cm⁻² to 0.6 mA cm⁻². The pulse width may be from 1 second to 10 second, or from 2 seconds to 8 seconds, or from 4 seconds to 6 seconds. The on-current is followed by an off-current at a lower current density for an amount of time determined by the duty cycle. The off-current may be from −1 A cm⁻² to 0.9 μA cm⁻², or from −0.1 μA cm⁻² to 0.1 μA cm⁻². The duty cycle may be from 0.1% to 99%, or from 50% to 99%, or from 70% to 99%. The sequential on-pulse and off-pulse is then repeated in a periodic manner until the appropriate mass of material has been electroplated. The interfacial layer may have a uniform thickness. The electrode may comprise lithium metal. The electrode may consist essentially of lithium metal. The current may produce between 1 and 300, between 5 and 60, between 10 and 30, or between 2 and 12 interfacial layers and corresponding electrochemical cells within an electrochemical device. The electrode may have a thickness between 1 nanometer and 100 micrometers, between 10 nanometers and 50 micrometers, or between 100 nanometers and 10 micrometers. The pulsed current may be applied for 0.01, 0.1, 0.5, 1, 2, 3, 4, 5, 6, 7, 8, 9, 10, 18, 24, or 48 hours, or more. The formation current may be applied all at once or over multiple charges.

### EXAMPLES

The following Examples are provided in order to demonstrate and further illustrate certain embodiments and aspects of the present invention and are not to be construed as limiting the scope of the invention.

### Example 1

### Cell Assembly

The garnet structured lithium lanthanum zirconium oxide (LLZO) was used as a solid-state Li-ion conductor for the electrodeposition of metallic Li films. The substrate for Li deposition was a 35 μm Ni foil (Targray) and the source of Li⁺ was a 200 μm Li foil (Alfa Aesar). To assemble the electrochemical cell, Ta-stabilized LLZO powder with a composition of Li_{6.5}La₃Zr_{1.5}Ta_{0.5}O₁₂ was synthesized as described by Rangasamy et al. [Ref. 12] and then simultaneously densified and diffusion-bonded to the Ni substrate by rapid-induction hot-pressing. The LLZO surface was then heat-treated in Ar to remove surface contaminants and the Li source was attached using a procedure previously described [Ref. 13].

### Li Metal Electrodeposition

After attaching the Li foil, the cell was heated in an Ar-filled glovebox in a custom cell fixture at a temperature of 160° C. under a pressure of ˜1 MPa. Li metal deposition is then performed at 160° C. by applying a constant current of 0.05 mA cm⁻² until the potential drops from the open-circuit potential to 0V vs. the Li electrode. When the potential reaches 0V, the program is switched to the pulse current scheme, such that the Li metal is deposited onto the Ni substrate during the on-current pulses. Electrochemical impedance spectroscopy (EIS) was performed before and after plating to confirm the presence of electroplated Li and to confirm the state-of-health of the cell. EIS was performed with a 1 mV perturbation voltage at frequencies between 500 mHz and 7 MHz.

### Electrochemical Analysis

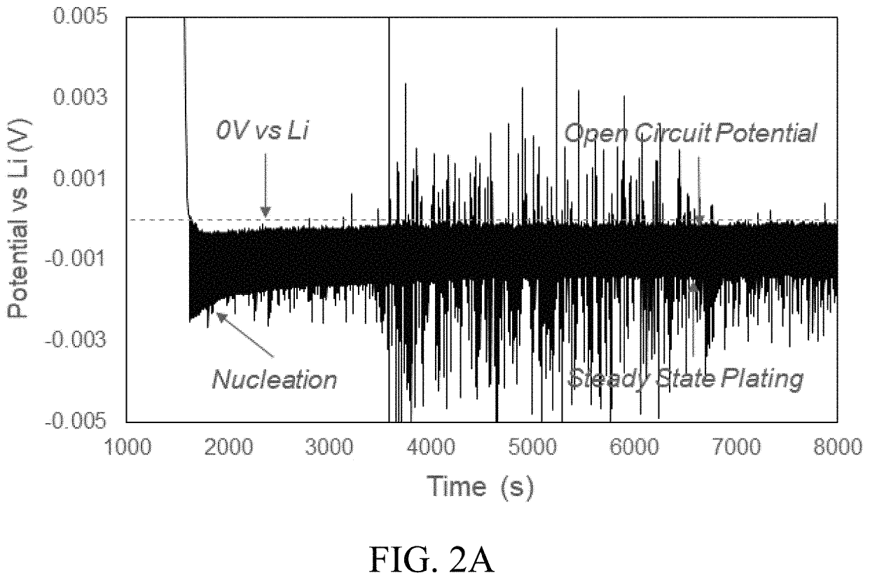

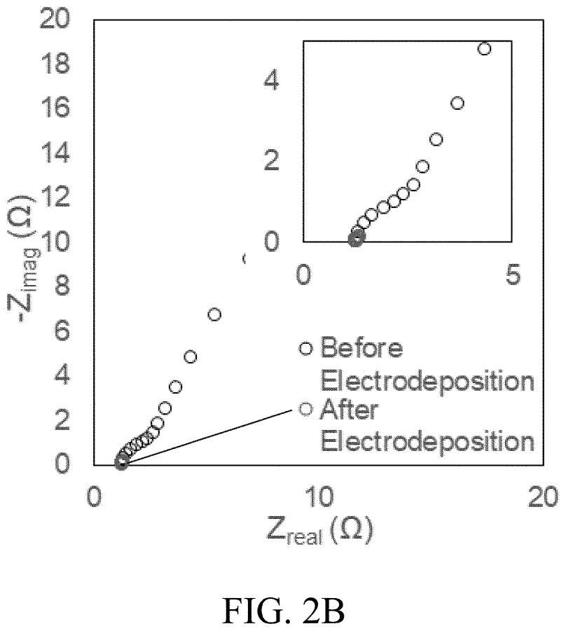

FIG. 2A shows the potential response with the Li metal source acting as the counter and reference electrode. It can be seen that as ionic current is passed toward the Ni substrate, the potential drops from the open circuit potential down to 0V and Li begins to electrodeposit below 0V vs. the Li electrode. When the potential reaches 0V, the current is switched from a constant DC current to a current pulse program, with on-currents between 0.1 mA cm⁻² and 0.6 mA cm⁻², off-currents of 0 mA cm⁻², a pulse width of 5 seconds, and duty cycles between 80% and 100% (DC current). The potential during the on-current pulses exhibit a minimum near the beginning of the pulse program, which is indicative of Li nucleation onto the substrate, while the steady state potential at higher times is representative of steady state Li deposition. The potential during the off-current pulses are close to 0V, which is representative of the open circuit potential of a Li/LLZO/Li cell. FIG. 2B shows the EIS spectra of the cell before and after the Li electrodeposition. As assembled, the EIS spectra exhibits a low frequency capacitive tail due to the blocking nature of Ni to Li [Ref. 14]. However, after the electrodeposition, the capacitive tail almost completely disappears, which more closely resembles a cell with non-blocking Li electrodes. This suggests that Li metal was successfully deposited at the interface. A defining feature of the plated Li is that it is very dense. The signatures in EIS is a transition from blocking to non-blocking behavior (see FIG. 2B) wherein non-blocking means that the electrode can be considered reactive with the lithium electroactive species. A leftward shift in the Re(Z)-axis intercept would denote the starting formation of dendrites. FIG. 2B shows a plot that does not show the formation of dendrites, showing that because there is no leftward shift, the cell has not internally short-circuited and thus is functional. Furthermore, the lack of change in the spectra at higher frequencies suggests that no damage to the solid electrolyte has occurred during the deposition process. Damage refers to Li dendrite penetration into the solid electrolyte. If dendrites form, a crack is created, i.e., a signature. The method of this example does not create dendrites, thus there is no signature in the form of a crack in the solid electrolyte.

### Visual Inspection

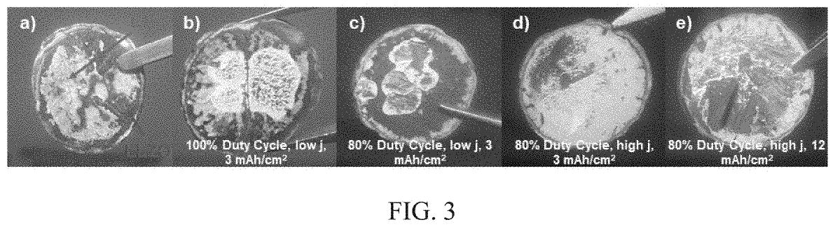

FIG. 3 in panels a) to e) shows the LLZO surface after removing the Ni substrate after Li electrodeposition. Given that the adhesion strength of Li on the LLZO is much greater than the adhesion strength of Li on Ni [Ref. 15], the majority of the Li remains stuck to the LLZO after removal of the Ni foil. It can be seen that a significant amount of Li can be plated, comparable to the thickness of the Ni substrate. The presence of metallic Li is consistent with the AC impedance and DC potential responses. FIG. 3 in panels a) to e) shows the distribution of the electrodeposited Li on the LLZO surface for different pulse parameters and it can be seen that there are drastic differences as the parameters are varied. A comparison between the 100% (DC current) and 83% duty cycles demonstrates the effectiveness of the current pulses in achieving uniform layers of electrodeposited Li. Furthermore, the comparison between the high and low on-current densities demonstrates the effect of the current density on the initial nucleation behavior and growth of the nuclei. FIG. 3 in panel b) is an exemplary electrodeposited lithium morphology for 100% duty cycle (DC current) according to one embodiment of the present disclosure. FIG. 3 in panel c) is an exemplary electrodeposited lithium morphology for 80% duty cycle and low current density according to one embodiment of the present disclosure. FIG. 3 in panel d) is an exemplary electrodeposited lithium morphology for 80% duty cycle and high current density according to one embodiment of the present disclosure. FIG. 3 in panel e) is an exemplary electrodeposited lithium morphology wherein a significant amount of lithium is deposited, exceeding the thickness of the nickel substrate according to one embodiment of the present disclosure. Without pulsing (see FIG. 3 in panel b)), the Li only covers about 60% of the LLZO surface. With the pulsing (see FIG. 3 in panels d)-e)), there is much better surface coverage, greater than 95%.

Therefore, it is clear that the pulse parameters can be optimized in order to achieve improved levels of uniformity in electrodeposited metals at solid-solid interfaces. Alternatively, the pulse parameters can also be optimized to create localized regions of thick electrodeposits.

### Example 2

### Overview

Example 2 relates to a method of electrodeposition of electroactive species at a solid-solid interface. It is demonstrated that an intermediate metal layer can be electrochemically deposited in a non-destructive manner at the interface between a solid-electrolyte and a metal foil. The necessary morphology of the solid-electrolyte/metal interface is characterized and identified. The following methodology can aid in the manufacturing of thin films for application in advanced functional materials and electrochemical devices.

### Introduction

Electrochemical deposition is a widely useful method of controlled manufacturing of microscopic structures and precision engineering of surfaces. In a typical electrodeposition process, the electroactive species, typically a metal cation, is electrochemically precipitated onto a metal substrate out of a liquid electrolyte. Because the electrolyte is in the liquid state, the volumetric expansion associated with the precipitation of the electroactive species is easily accommodated. However, in the case of a solid-electrolyte bound to the metal substrate, this volumetric expansion is not as easily accommodated and must force delamination of the electrolyte and metal substrate to accommodate the growth of an intermediate phase. Based on the mechanical properties and geometry of both the electrolyte and the metal substrate, the forced delamination required to electrodeposit the electroactive species can cause irreversibly fracture either component [Ref. 16-19]. Furthermore, the stresses induced by the electrodeposition process is directly correlated to the electrochemical conditions, including interfacial resistance and electrodeposition currents. With the development of solid-electrolytes for battery and fuel cell applications, electrodeposition at solid-solid interfaces is becoming increasingly necessary to precisely manufacture active metal films at solid-solid interfaces. Therefore, robust, non-destructive methods for electrodeposition of electroactive materials at solid-solid interfaces is necessary.

### Cell Assembly

The lithium lanthanum zirconium oxide (LLZO) was used as a solid-state Li-ion conductor for electrodeposition of metallic Li films. The substrate for Li deposition was a 10 μm Cu foil (Targray) and the source of Li⁺ was a 500 μm Li foil (Alfa Aesar). The electrochemical cell is assembled by first synthesizing and densifying Ta-stabilized LLZO as described by Taylor et al. [Ref. 20]. The LLZO is then cut into 2 mm disks, polished with 1200 grit sandpaper and diffusion-bonded to the Cu substrate by rapid-induction hot-pressing for 5 minutes at 900° C. The structure is then heat-treated in Ar and the Li foil is attached at 170° C. under a pressure of −1 MPa as previously described [Ref. 21].

### Li Metal Electrodeposition

Li metal deposition is conducted at room temperature by applying a constant current of 0.05 mA cm⁻² until the desired amount of Li metal is deposited onto the Cu substrate under a pressure of 4 MPa at room temperature. Electrochemical impedance spectroscopy is performed before and after plating to confirm the presence of electroplated Li and to confirm the state-of-health of the cell. EIS is performed with a 5 mV perturbation voltage at frequencies between 500 mHz and 7 MHz.

### Materials Characterization

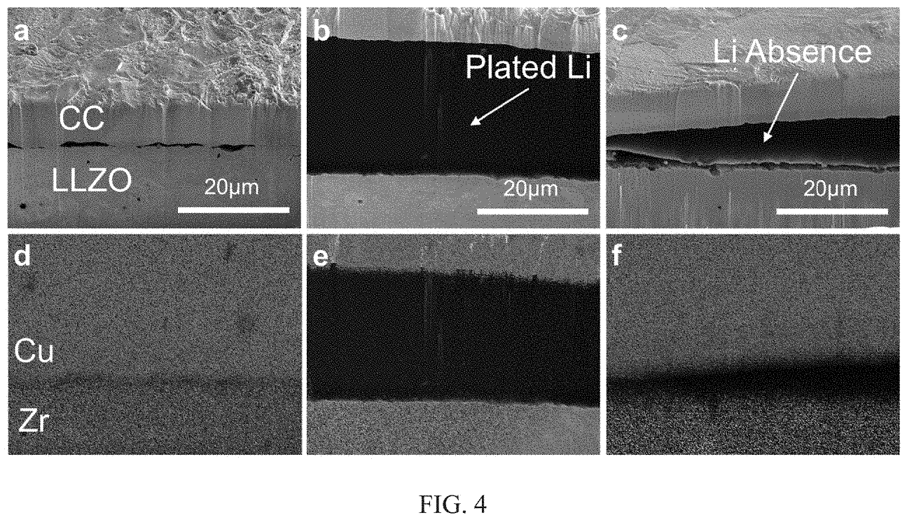

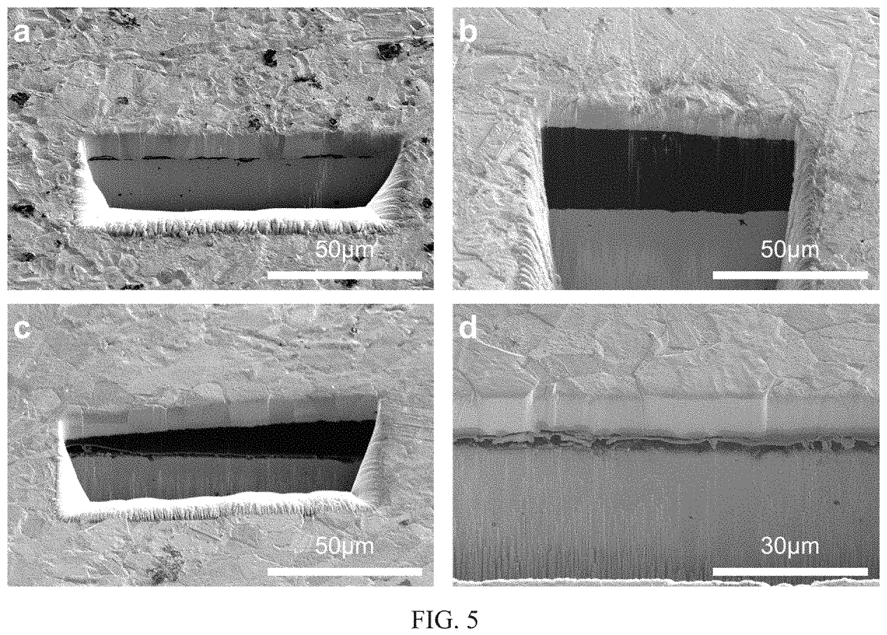

Cross-sections were cut using focused ion beam (FIB) milling, imaged, and analyzed under scanning electron microscopy (SEM) and energy dispersive x-ray spectroscopy (EDS) using a Thermo Fisher Helios G4 Plasma FIB UXe. FIG. 4 shows the cross-sectional SEM of the cell assembly. FIG. 4 in panel a shows a pristine cell after assembly, depicting minimal gaps between the Cu and LLZO layers. FIG. 4 in panel b shows the interface after plating of 5 mAh cm⁻² of Li metal, showing the appearance of an intermediate phase. The intermediate phase is unidentifiable under EDS, suggesting the identity is Li metal since Li metal is outside the detectable range of the technique. FIG. 4 in panel c shows the interface after stripping of the 5 mAh cm⁻² of Li under the opposite polarity current. It is seen that the intermediate phase disappears and is replaced with a 5-10 μm gap, further suggesting Li metal as the identity of the intermediate phase. FIG. 5 in panels a-c shows the same cross sections at lower magnifications to providing more detail in the homogeneity of the interface morphologies observed. FIG. 5 in panel d also shows an alternative morphology of the interface after Li stripping, which shows a less prominent gap than in FIG. 5 in panel c but more noticeable than the pristine interface shown in FIG. 5 in panel a.

Thus, the present invention provides a method of electrodeposition using pulsed currents to improve the uniformity of electrodeposited materials at solid-solid interfaces. In one embodiment, the method provides for anode-free manufacturing in which a battery is fabricated in the discharged state, with a bare current collector replacing the conventional anode, and a metal anode is then formed electrochemically on the first charge cycle by electroplating a metal contained within the cathode.

In light of the principles and example embodiments described and illustrated herein, it will be recognized that the example embodiments can be modified in arrangement and detail without departing from such principles. Also, the foregoing discussion has focused on particular embodiments, but other configurations are also contemplated. In particular, even though expressions such as “in one embodiment”, “in another embodiment,” or the like are used herein, these phrases are meant to generally reference embodiment possibilities, and are not intended to limit the invention to particular embodiment configurations. As used herein, these terms may reference the same or different embodiments that are combinable into other embodiments. As a rule, any embodiment referenced herein is freely combinable with any one or more of the other embodiments referenced herein, and any number of features of different embodiments are combinable with one another, unless indicated otherwise.

Although the invention has been described in considerable detail with reference to certain embodiments, one skilled in the art will appreciate that the present invention can be used in alternative embodiments to those described, which have been presented for purposes of illustration and not of limitation. Therefore, the scope of the appended claims should not be limited to the description of the embodiments contained herein.

### REFERENCES

[1] Sobha Jayakrishnan D., “5—Electrodeposition: the versatile technique for nanomaterials”, In: Saji V S, Cook R, editors. Corrosion Protection and Control Using Nanomaterials, Woodhead Publishing; 2012, p. 86-125. doi:10.1533/9780857095800.1.86.
[2] Guo L., Searson P. C., “On the influence of the nucleation overpotential on island growth in electrodeposition”, Electrochimica Acta 2010; 55:4086-91. doi:10.1016/j.electacta.2010.02.038.
[3] Chandrasekar M. S., Pushpavanam M., “Pulse and pulse reverse plating-Conceptual, advantages and applications”, Electrochimica Acta 2008; 53:3313-22. doi:10.1016/j.electacta.2007.11.054.
[4] Witten T. A., Sander L. M., “Diffusion-Limited Aggregation, a Kinetic Critical Phenomenon”, Phys Rev Lett 1981; 47:1400-3. doi:10.1103/PhysRevLett.47.1400.
[5] Popov K. I., Maksimović M. D., Trnjančev J. D., Pavlović M. G. “Dendritic electrocrystallization and the mechanism of powder formation in the potentiostatic electrodeposition of metals”, Journal of Applied Electrochemistry 1981; 11:239-246.
[6] Schmidt J. A., Prat M. R., Bazán J. C., “Copper electrodeposition on glassy carbon from a solid electrolyte”, Electrochimica Acta 1993; 38:577-80. doi:10.1016/0013-4686(93)85015-Q.
[7] Motoyama M., Ejiri M., Iriyama Y., “Modeling the Nucleation and Growth of Li at Metal Current Collector/LiPON Interfaces”, Journal of The Electrochemical Society 2015; 162:A7067-71. doi:10.1149/2.0051513jes.
[8] Kruempelmann J., Dietzel D., Schirmeisen A., Yada C., Rosciano F., Roling B., “Nanoscale electrochemical measurements on a lithium-ion conducting glass ceramic: In-situ monitoring of the lithium particle growth”, Electrochemistry Communications 2012; 18:74-7. doi:10.1016/j.elecom.2012.02.019.
[9] Qi W., Peng Y., Han Y., Bowles R. K., Dijkstra M., “Nonclassical Nucleation in a Solid-Solid Transition of Confined Hard Spheres”, Phys Rev Lett 2015; 115:185701. doi:10.1103/PhysRevLett.115.185701.
[10] Mnyukh Y., “Phase Transitions, Solid-State Reactions, Nucleation, Interface, Kinetics, Crystal Growth, Crystal Defects, Molecular Mechanism”, American Journal of Condensed Matter Physics 2013; 3:89-103. doi:10.5923/j.ajcm p.20130304.01.
[11] Taylor E. J., Zhou C., Renz R. P., Sunkara M. K., “Electrolysis of electroactive species using pulsed current”, WO 1997000830A1, 1997.
[12] Rangasamy E., Wolfenstine J., Allen J., Sakamoto J., “The effect of 24c-site (A) cation substitution on the tetragonal—cubic phase transition in Li₇₋ₓLa₃₋ₓAₓZr₂O₁₂ garnet-based ceramic electrolyte”, Journal of Power Sources 2013; 230:261-6. doi:10.1016/j.jpowsour.2012.12.076.
[13] Wang M., Wolfenstine J. B., Sakamoto J., “Temperature dependent flux balance of the Li/Li₇La₃Zr₂O₁₂ interface”, Electrochimica Acta 2019; 296:842-7. doi:10.1016/j.electacta.2018.11.034.
[14] Huggins R. A., “Simple method to determine electronic and ionic components of the conductivity in mixed conductors a review”, Ionics 2002; 8:300-313.
[15] Wang M., Sakamoto J., “Correlating the interface resistance and surface adhesion of the Li metal-solid electrolyte interface”, Journal of Power Sources 2018; 377:7-11. doi:10.1016/j.jpowsour.2017.11.078.
[16] Krauskopf, T. et al., “Lithium-Metal Growth Kinetics on LLZO Garnet-Type Solid Electrolytes”, Joule S2542435119303010 (2019) doi:10.1016/j.joule.2019.06.013.
[17] Motoyama, M., Ejiri, M. & Iriyama, Y., “Modeling the Nucleation and Growth of Li at Metal Current Collector/LiPON Interfaces”, J. Electrochem. Soc. 162, A7067-A7071 (2015).
[18] Motoyama, M. et al., “The Active Interface of Ta-Doped Li₇La₃Zr₂O₁₂ for Li Plating/Stripping Revealed by Acid Aqueous Etching”, ACS Appl. Energy Mater. acsaem.9b01193 (2019) doi:10.1021/acsaem.9b01193.
[19] Motoyama, M., Ejiri, M. & Iriyama, Y., “In-Situ Electron Microscope Observations of Electrochemical Li Deposition/Dissolution with a LiPON Electrolyte”, Electrochemistry 82, 364-368 (2014).
[20] Taylor, N. J. et al., “Demonstration of high current densities and extended cycling in the garnet Li₇La₃Zr₂₀₁₂ solid electrolyte”, J. Power Sources 396, 314-318 (2018).
[21] Wang, M., Wolfenstine, J. B. & Sakamoto, J., “Temperature dependent flux balance of the Li/Li₇La₃Zr₂O₁₂ interface”, Electrochimica Acta 296, 842-847 (2019).
   The citation of any document is not to be construed as an admission that it is prior art with respect to the present invention.

What is claimed is:

1. A method of making an electrochemical device, the method comprising:
(a) providing a current collector clad with a solid-state electrolyte material;
(b) placing the solid-state electrolyte material in contact with an electrode comprising an electroactive species to form a layered structure;
(c) applying a pressure greater than 0 MPa to the layered structure; and
(d) passing a current using a series of pulse cycles through the layered structure to create an interfacial layer comprising the electroactive species between the solid-state electrolyte material and the current collector, the interfacial layer functioning as an anode of the electrochemical device and the electrode functioning as a cathode of the electrochemical device.

2. The method of claim 1, wherein step (c) comprises applying a pressure from 0.1 MPa to 100 MPa to the layered structure.

3. The method of claim 1, wherein step (c) comprises applying a pressure from 1 MPa to 10 MPa to the layered structure.

4. The method of claim 1, wherein:
each pulse cycle comprises (i) applying an on-current for a given pulse width, and (ii) applying an off-current for an amount of time based on a duty cycle and the pulse width, and
the off-current has a first current density value which is less than a second current density value of the on-current.

5. The method of claim 4, wherein the on-current is direct current in a range of 1 μA cm⁻² to 1 A cm⁻².

6. The method of claim 4, wherein the on-current is direct current in a range of 0.01 mA cm⁻² to 1 mA cm⁻².

7. The method of claim 1, wherein the current is direct current in a range of 1 μA cm⁻² to 1 mA cm⁻².

8. The method of claim 4, wherein the pulse width is from 1 microsecond to 100 seconds.

9. The method of claim 4, wherein the pulse width is from 1 second to 10 seconds.

10. The method of claim 4, wherein the off-current is direct current in a range of −1 A cm⁻² to 0.9 μA cm⁻².

11. The method of claim 4, wherein the duty cycle is from 0.1° A to 99%.

12. The method of claim 4, wherein the duty cycle is from 50% to 99%.

13. The method of claim 4, wherein the duty cycle is from 70% to 99%.

14. The method of claim 4, wherein the duty cycle is from 80% to 99%.

15. The method of claim 1 wherein:
step (d) further comprises monitoring propagation of the electroactive species from the anode into the solid state electrolyte during passing the current using the series of pulse cycles through the layered structure,
each pulse cycle comprises (i) applying an on-current for a given pulse width, and (ii) applying an off-current for an amount of time based on a duty cycle and the pulse width, and
step (d) further comprises varying at least one of: (i) the pulse width, (ii) the amount of time, (iii) the duty cycle, (iv) a first current density value of the off-current, and (iv) a second current density value of the on-current, when a prediction of propagation of the electroactive species from the anode into the solid state electrolyte is made from the monitoring.

16. The method of claim 1, wherein the current collector comprises a single material comprising a metal or a metal alloy.

17. The method of claim 16, wherein the current collector comprises a material selected from the group consisting of nickel, molybdenum, titanium, zirconium, tantalum, alloy steel, stainless steel, nickel based super alloys, cobalt based super alloys, copper, aluminum, iron, or mixtures thereof.

18. The method of claim 1, wherein the current collector has a thickness between 1 nanometer and 100 micrometers.

19. The method of claim 1, wherein the solid-state electrolyte material comprises a material selected from the group consisting of lithium phosphorous oxynitride (LiPON), oxide based garnets, sodium super ionic conductors (NaSICON), lithium super ionic conductors (LiSICON), thio-LiSICONs, sulfide glass, polymers, or mixtures thereof.

20. The method of claim 1, wherein the solid-state electrolyte material is selected from the group consisting of lithium lanthanum zirconium oxide (LLZO), aluminum doped LLZO, gallium doped LLZO, niobium doped LLZO, tantalum doped LLZO, lithium aluminum titanium phosphate (LATP), lithium aluminum germanium phosphate (LAGP), lithium phosphorous sulfide (LPS), poly(ethylene oxide) (PEO), polyacrylonitrile (PAN), crystalline thermoplastic polymers, alkali metal cation-alumina, metal halides, or mixtures thereof.

21. The method of claim 1, wherein the solid-state electrolyte material comprises lithium lanthanum zirconium oxide (LLZO) or a derivative thereof.

22. The method of claim 1, wherein the solid-state electrolyte material comprises a ceramic material having a formula of Li_{w}AₓM₂Re_{3-y}O_{z},
wherein w is 5-7.5,
wherein A is selected from B, Al, Ga, In, Zn, Cd, Y, Sc, Mg, Ca, Sr, Ba, and any combination thereof,
wherein x is 0-2,
wherein M is selected from Zr, Hf, Nb, Ta, Mo, W, Sn, Ge, Si, Sb, Se, Te, and any combination thereof,
wherein Re is selected from lanthanide elements, actinide elements, and any combination thereof,
wherein y is 0-0.75,
wherein z is 10.875-13.125, and
wherein the ceramic material has a garnet-type or garnet-like crystal structure.

23. The method of claim 22, wherein M is a combination of Zr and Ta.

24. The method of claim 22, wherein M is Zr, and A is Al, and x is not 0.

25. The method of claim 22, wherein M is Zr, and A is Ga, and x is not 0.

26. The method of claim 1, wherein the solid-state electrolyte material is sodium-β-alumina and sodium-β″-alumina.

27. The method of claim 1, wherein the solid-state electrolyte material is clad onto the current collector using at least one of diffusion-bonding, chemical vapor deposition, physical vapor deposition, atomic layer deposition, slurry casting and sintering, slurry casting and hot pressing, painting, powder coating, thermal spraying, cold spraying, aerosol deposition, flux deposition, electrodeposition, electroless chemical deposition, or combinations thereof.

28. The method of claim 1, wherein the solid-state electrolyte material has a thickness between 1 nanometer and 100 micrometers.

29. The method of claim 1, wherein the interfacial layer has a thickness between 1 nanometer and 100 micrometers.

30. The method of claim 1, wherein the current collector is electrochemically blocking to the electroactive species.

31. The method of claim 1, wherein the current collector comprises a bimetal having a first layer comprising a first metallic material and a second layer comprising a second metallic material, the first layer at least partially contacting the solid-state electrolyte material before step (d), and the second layer contacting the first layer.

32. The method of claim 31, wherein the first metallic material is electrochemically blocking to the electroactive species.

33. The method of claim 31 wherein:
the first metallic material is selected from the group consisting of nickel, molybdenum, titanium, zirconium, tantalum, nickel based super alloys, cobalt based super alloys, copper, or mixtures thereof, and
the second material is selected from the group consisting of aluminum, nickel, alloy steel, stainless steel, nickel based super alloys, or mixtures thereof.

34. The method of claim 31 wherein:
the first metallic material comprises nickel, and
the second material comprises stainless steel.

35. The method of claim 31, wherein the first layer has a thickness between 1 nanometer and 100 micrometers, and the second layer has a thickness between 1 nanometer and 100 micrometers.

36. The method of claim 1, wherein the electrode comprises a single material comprising a metal or a metal alloy.

37. The method of claim 1, wherein the electrode comprises a material selected from the group consisting of lithium, sodium, silver, magnesium, calcium, cobalt, iron, potassium, copper, or mixtures thereof.

38. The method of claim 1, wherein the electrode comprises lithium.

39. The method of claim 1, wherein the electrode comprises a lithium host material is selected from the group consisting of (i) LiC₆, (ii) lithium metal oxides wherein the metal is one or more aluminum, cobalt, iron, manganese, nickel and vanadium, and (iii) lithium-containing phosphates having a general formula LiMPO₄ wherein M is one or more of cobalt, iron, manganese, and nickel.

40. The method of claim 39, wherein the electrode further comprises a binder and a conductive additive.

41. The method of claim 40, wherein the binder comprises a polymeric material, and the conductive additive comprises a carbon compound.

42. The method of claim 1, wherein the electrode is a conductive composite comprising the electroactive species.

43. The method of claim 1, wherein step (b) comprises evaporating a first layer of lithium on the solid-state electrolyte material and thereafter pressing a lithium foil to the first layer such that the electrode comprises the first layer of lithium and the lithium foil.

44. The method of claim 1, wherein step (c) comprises applying the pressure to the layered structure at a temperature from 25° C. to 180° C.

45. The method of claim 1, wherein no damage to the solid electrolyte material occurs during step (d).

46. The method of claim 1, wherein no dendrite penetration into the solid electrolyte material occurs during step (d).

47. The method of claim 1, wherein the interfacial layer has a uniform thickness after step (d).

48. The method of claim 1, wherein the interfacial layer has a surface coverage of 5% or greater with the solid-state electrolyte after step (d).

49. The method of claim 1, wherein the interfacial layer has a surface coverage of 70% or greater with the solid-state electrolyte after step (d).

50. The method of claim 1, wherein the interfacial layer has complete surface contact with the solid-state electrolyte material after step (d).

51. The method of claim 1, wherein the current collector clad with the solid-state electrolyte material provided in step (a) has a porosity between 0.1% and 99% at an interface between the current collector and the solid-state electrolyte material.

52. The method of claim 1, wherein the current collector clad with the solid-state electrolyte material provided in step (a) has a porosity between 0.1% and 10% at an interface between the current collector and the solid-state electrolyte material.

53. The method of claim 1, wherein an interfacial resistance between the current collector and the solid-state electrolyte material provided in step (a) is less than 10,000 ohm cm².

54. The method of claim 1, wherein an interfacial resistance between the current collector and the solid-state electrolyte material provided in step (a) is less than 1,000 ohm cm².

55. The method of claim 1, wherein an interfacial resistance between the interfacial layer and the solid state electrolyte after step (d) is less than 100 ohm cm².

56. The method of claim 1, wherein an interfacial resistance between the interfacial layer and the solid state electrolyte after step (d) is less than 25 ohm cm².

57. The method of claim 1, wherein an RMS surface roughness of a surface of the solid state electrolyte material clad with the current collector is 5 micrometers or less.

58. The method of claim 1, wherein an RMS surface roughness of a surface of the solid state electrolyte material clad with the current collector is 500 nanometers or less.

59. The method of claim 1, wherein the interfacial layer has a density such that the anode exhibits non-blocking behavior to the electroactive species.

60. The method of claim 1, wherein the interfacial layer does not show the formation of dendrites after step (d).

61. A method of making an electrochemical device, the method comprising:
(a) providing a current collector clad with a solid-state electrolyte material comprising a doped lithium lanthanum zirconium oxide;
(b) placing the solid-state electrolyte material in contact with an electrode comprising an electroactive species to form a layered structure; and
(c) passing a current using a series of pulse cycles through the layered structure to create an interfacial layer comprising the electroactive species between the solid-state electrolyte material and the current collector, the interfacial layer functioning as an anode of the electrochemical device and the electrode functioning as a cathode of the electrochemical device.

62. The method of claim 61, wherein the solid-state electrolyte material comprises aluminum doped lithium lanthanum zirconium oxide, or gallium doped lithium lanthanum zirconium oxide, or niobium doped lithium lanthanum zirconium oxide, or tantalum doped lithium lanthanum zirconium oxide.

63. The method of claim 61, wherein the solid-state electrolyte material comprises a ceramic material having a formula of Li_{w}AₓM₂Re_{3-y}O_{z},
wherein w is 5-7.5,
wherein A is selected from B, Al, Ga, In, Zn, Cd, Y, Sc, Mg, Ca, Sr, Ba, and any combination thereof,
wherein x is 0-2,
wherein M is selected from Zr or any combination of Zr, Hf, Nb, Ta, Mo, W, Sn, Ge, Si, Sb, Se, and Te,
wherein Re is lanthanum,
wherein y is 0-0.75,
wherein z is 10.875-13.125, and
wherein the ceramic material has a garnet-type or garnet-like crystal structure.

64. The method of claim 63, wherein M is a combination of Zr and Ta.

65. The method of claim 63, wherein M is Zr, and A is Al, and x is not 0.

66. The method of claim 63, wherein M is Zr, and A is Ga, and x is not 0.

67. The method of claim 63, wherein step (c) further comprises applying a pressure greater than 0 MPa to the layered structure.

68. A method of making an electrochemical device, the method comprising:
(a) providing a current collector clad with a solid-state electrolyte material;
(b) placing the solid-state electrolyte material in contact with an electrode comprising an electroactive species to form a layered structure; and
(c) passing a current using a series of pulse cycles through the layered structure to create an interfacial layer comprising the electroactive species between the solid-state electrolyte material and the current collector, the interfacial layer functioning as an anode of the electrochemical device and the electrode functioning as a cathode of the electrochemical device,
wherein the solid-state electrolyte material comprises a ceramic material having a formula of Li_{w}AₓM₂Re_{3-y}O_{z},
wherein w is 5-7.5,
wherein A is selected from B, Al, Ga, In, Zn, Cd, Y, Sc, Mg, Ca, Sr, Ba, and any combination thereof,
wherein x is 0-2,
wherein M is selected from Zr, Hf, Nb, Ta, Mo, W, Sn, Ge, Si, Sb, Se, Te, and any combination thereof,
wherein Re is selected from lanthanide elements, actinide elements, and any combination thereof,
wherein y is 0-0.75,
wherein z is 10.875-13.125,
wherein the ceramic material has a garnet-type or garnet-like crystal structure, and
wherein when x is 0, M is two or more of Zr, Hf, Nb, Ta, Mo, W, Sn, Ge, Si, Sb, Se, and Te.

69. The method of claim 68, wherein Re is lanthanum.

70. The method of claim 69, wherein M is a combination of Zr and Ta.

71. The method of claim 69, wherein M is Zr, and A is Al, and x is not 0.

72. The method of claim 69, wherein M is Zr, and A is Ga, and x is not 0.

73. The method of claim 68, wherein the solid-state electrolyte comprises Li_{6.5}La₃Zr_{1.5}Ta_{0.5}O₁₂.

74. The method of claim 62, wherein step (c) further comprises applying a pressure of greater than 0 MPa to the layered structure.
